(19) United States
(12) Patent Application Publication
(10) Pub. No.: US 2023/0086446 A1
(43) Pub. Date: Mar. 23, 2023

(54) COPPER-PLATINUM NANOCOMPOSITE ELECTRODES

(71) Applicants: Ana dos Santos Fajardo, Marinha Grande (PT); Sergio Garcia-Segura, Tempe, AZ (US); Gabriel Cerron Calle, Tempe, AZ (US); Carlos M. Sanchez, Paris (FR)

(72) Inventors: Ana dos Santos Fajardo, Marinha Grande (PT); Sergio Garcia-Segura, Tempe, AZ (US); Gabriel Cerron Calle, Tempe, AZ (US); Carlos M. Sanchez, Paris (FR)

(21) Appl. No.: 17/946,185

(22) Filed: Sep. 16, 2022

Related U.S. Application Data
(60) Provisional application No. 63/245,784, filed on Sep. 17, 2021.

(51) Int. Cl. H01M 4/38; H01M 4/04; H01M 4/66; H01M 4/74

(52) U.S. Cl. CPC H01M 4/38; H01M 4/0404; H01M 4/045; H01M 4/661; H01M 4/745; H01M 2004/021

(57) ABSTRACT

A nanocomposite electrode includes a porous copper substrate and platinum nanoparticles electrolytically deposited on the porous copper substrate. Making a nanocomposite electrode includes contacting a porous copper substrate with a solution including platinum, and electrodepositing the platinum on the porous copper substrate.

### CROSS-REFERENCE TO RELATED APPLICATION

This application claims the benefit of U.S. Patent Application No. 63/245,784 filed on Sep. 17, 2021, which is incorporated herein by reference in its entirety.

### STATEMENT OF GOVERNMENT SUPPORT

This invention was made with government support under 1449500 awarded by the National Science Foundation. The government has certain rights in the invention.

### TECHNICAL FIELD

This invention relates to copper-platinum nanocomposite electrodes, methods of fabricating the electrodes, and use of the electrodes (e.g., for electrocatalytic reduction of nitrate to ammonia).

### BACKGROUND

Ammonia is a major component in most crop fertilizer formulations that are essential to secure global food supply. Despite the benefits of ammonia production, indirect hazardous effects related to ammonia usage causes serious environmental problems related to the anthropogenic disruption of the natural nitrogen cycle. Ammonia leached into ground and surface waters is easily transformed in the environment via biotic and abiotic processes to nitrate. Nitrate pollution in waters is due to anthropogenic activities including but not limited to fertilizer runoff from crops, animal farming, and industrial wastewater.

### SUMMARY

This disclosure relates to electrocatalytic copper-platinum nanocomposite electrodes on porous (foam) substrates, methods of fabricating the electrodes, and use of the electrodes (e.g., for electrocatalytic reduction of nitrate to ammonia). These Cu—Pt nanocomposite foam electrodes enhance electrochemical reduction of nitrate (ERN) by the introduction of bimetallic catalytic sites. Growth of platinum nanoparticles on the surface of porous copper substrates (e.g., copper foam) alter the electrocatalytic response of electrodes, e.g., by synergistic effects induced by Cu—Pt nanointerfaces that promote hybridized mechanisms of catalytic electrochemical and hydrogenation reduction processes. These bimetallic active catalytic sites present a higher nitrate conversion than monometallic copper electrodes at least in part by overcoming the limiting step related with nitrate to nitrite initial reduction reaction. While the copper surface facilitates the reduction of nitrate to nitrite, the platinum nanoparticles facilitate the conversion of nitrite to ammonia.

In one example, Cu—Pt composite electrodes were synthesized by electrodeposition with different amounts of Pt controlled by time. Platinum nanoparticle growth on the surface of copper foam changed the electrocatalytic response of electrodes, e.g., by the synergistic effects induced by Cu—Pt nanointerfaces that enable hybridized mechanisms of catalytic electrochemical and hydrogenation reduction processes. These new bimetallic active catalytic sites present a higher nitrate conversion by overcoming the limiting step related with nitrate to nitrite initial reduction reaction. While the copper surface promotes the reduction of nitrate to nitrite, platinum nanoparticles facilitate the conversion of nitrite to ammonia.

A copper foam electrode demonstrates 55% nitrate conversion, while Cu—Pt electrodes show higher nitrate conversion. Cu—Pt 180 s presented almost total nitrate conversion (˜94%), k₁=4.03×10⁻⁴ s⁻¹, 194.4 mg NH₃—N L⁻¹ g_{cat}⁻¹, and S_{NH}_{₃}=84% in only 120 min. The lowest value of electrical energy per order was 13 kWh m⁻³ order⁻¹ for the Cu—Pt 180 s, suggesting that this is a suitable quantity of platinum on the copper foam surface. Cu—Pt electrodes may be advantageous for the treatment of contaminated water streams containing nitrate, while providing an opportunity for circular economy by enabling decentralized ammonia recovery from polluted water sources.

In a first general aspect, a nanocomposite electrode includes a porous copper substrate and platinum nanoparticles electrolytically deposited on the porous copper substrate.

Implementation of the first general aspect can include one or more of the following features.

An average size of the platinum nanoparticles is typically in a range of 50 nm to 500 nm. The platinum nanoparticles can include 0.1 wt % to 1 wt % of the nanocomposite electrode. The porous copper substrate can be a copper foam, and the copper foam can have a porosity in a range of about 5 to about 200 pores per inch (ppi). The platinum nanoparticles typically extend from pore surfaces of the porous substrate. The platinum nanoparticles can be bound to the porous substrate. In some cases, a volume of the nanocomposite electrode is at least 0.1 cm².

In a second general aspect, a method of making a nanocomposite electrode includes contacting a porous copper substrate with a solution comprising platinum, and electrodepositing the platinum on the porous copper substrate to yield the nanocomposite electrode.

Implementations of the second general aspect can include one or more of the following features.

The porous copper substrate can be a copper foam. In some cases, the solution includes a platinum salt and a strong acid. A concentration of the platinum salt in the solution can be in a range of 1 mmolL⁻¹ to 10 mmolL⁻¹. Electrodepositing the platinum on the porous copper substrate can include forming platinum nanoparticles on surfaces of the porous copper substrate. An average size of the platinum nanoparticles is typically in a range of 50 nm to 500 nm. In certain cases, the platinum nanoparticles include 0.1 wt % to 1 wt % of the nanocomposite electrode.

Reducing nitrate to ammonia can include contacting the nanocomposite electrode of the first general aspect with an aqueous solution containing nitrate, and electrocatalytically reducing the nitrate to yield ammonia. In some cases, reducing nitrate to ammonia includes electrocatalytically reducing the nitrate to yield nitrite, and electrocatalytically reducing the nitrite to yield ammonia. Electrocatalytically reducing the nitrate to yield nitrite can be facilitated by copper in a porous copper substrate or platinum in the platinum nanoparticles. Electrocatalytically reducing the nitrate to ammonia typically has a selectivity of at least 80%.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1A is a schematic view of the electrocatalytic reduction of nitrate to ammonia on an embodiment of a copper-platinum nanocomposite electrode as described herein. FIG. 1B shows scanning electron microscope (SEM) images of a nanocomposite electrode including a porous Cu substrate with electrolytically deposited platinum nanoparticles (inset).

FIG. 2A shows X-ray diffraction (XRD) patterns of the Cu foam and Cu—Pt at different times of electrodeposition. FIG. 2B shows the X-ray photoelectron spectroscopy (XPS) spectra of Cu 2p in copper foam. FIG. 2C shows the XPS spectra of Cu 2p in Cu—Pt 180 s electrode. FIG. 2D shows a wide scan XPS spectra for Cu—Pt electrode.

FIGS. 3A and 3B show SEM images of Cu foam. FIGS. 3C-3G show SEM images of Cu—Pt nanocomposite electrodes after 60 s, 120 s, 180 s, and 360 s, respectively. The insets show SEM images at higher magnification.

FIG. 4A shows cyclic voltammetry at 10 mV s⁻¹ of copper foam in absence and presence of NaNO₃. FIG. 4B shows cyclic voltammetry at 10 mV s⁻¹ of copper foam with different concentrations of NaNO₃. FIG. 4C depicts Linear Sweep Voltammetry at 10 mV s⁻¹ of copper foam in Na₂SO₄, NaNO₃ and NaNO₂ in the range of 0.0 V to −2.0 V vs Ag/AgCl. FIG. 4D shows cyclic voltammetry at 10 mV s⁻¹ of Cu—Pt 180 s electrode in absence and presence of NaNO₃.

FIG. 5A shows [NO₃⁻—N] conversion. FIG. 5B shows [NO₂₋—N] evolution. FIG. 5C shows [NH₃—N] evolution over time for the electroreduction of 30 mg L⁻¹ NO₃⁻—N in 12.5 mM Na₂SO₄ at 0.09 A, using (⋄) Cu foam, (▴) Cu—Pt 60 s, (▪) Cu—Pt 120 s, (●) Cu—Pt 180 s and (▾) Cu—Pt 360 s, as cathodic materials.

FIG. 6A shows the amount of NH₃—N electrogenerated by mass of electrocatalyst used (bars) and Faradaic efficiency (crosses) for Cu foam, Cu—Pt 60 s, Cu—Pt 120 s, Cu—Pt 180 s and Cu—Pt 360 s. FIG. 6B shows the selectivity towards ammonia for the different Pt loadings ((▴) Cu—Pt 60 s, (▪) Cu—Pt 120 s, (●) Cu—Pt 180 s and (▾) Cu—Pt 360 s). Values given correspond to measurement at the end of 120 min of electrochemical reduction treatment.

FIG. 7 shows the energy consumption per order after 360 min (bars) and cell potential average (crosses) for the electroreduction of 30 mg L⁻¹ NO₃⁻—N in 12.5 mM Na₂SO₄ at 0.09 A, using Cu foam, Cu—Pt 60 s, Cu—Pt 120 s, Cu—Pt 180 s and Cu—Pt 360 s, as cathodic materials.

FIGS. 8A and 8B show nitrogenated species evolution ((◯) NO₃⁻—N, (▴) NO₂⁻—N, (▪) NH₃—N, and (●) N₂—N) over time for the electroreduction of 30 mg L⁻¹ NO₂⁻—N or 30 mg L⁻¹ NH₃—N, respectively in 12.5 mM Na₂SO₄ at 0.09 A, using Cu foam as cathode.

### DETAILED DESCRIPTION

This disclosure relates to electrocatalytic copper-platinum nanocomposite electrodes on porous (foam) substrates, methods of fabricating the electrodes, and use of the electrodes (e.g., for electrocatalytic reduction of nitrate to ammonia). These Cu—Pt nanocomposite porous electrodes facilitate electrochemical reduction of nitrate (ERN) by the introduction of bimetallic catalytic sites, enhancing activity, selectivity, and stability of the electrode due at least in part to synergistic interactions between the platinum and the copper.

The electrochemical reduction of nitrate (ERN) can selectively reduce nitrate to ammonia (Eq. 1). Sustainable ERN from polluted water sources holds the potential to enable fossil-free ammonia production through N-recycling approaches when operated with renewable energy sources.

NO₃⁻+9H⁺+8e⁻→NH₃+3H₂O (1)

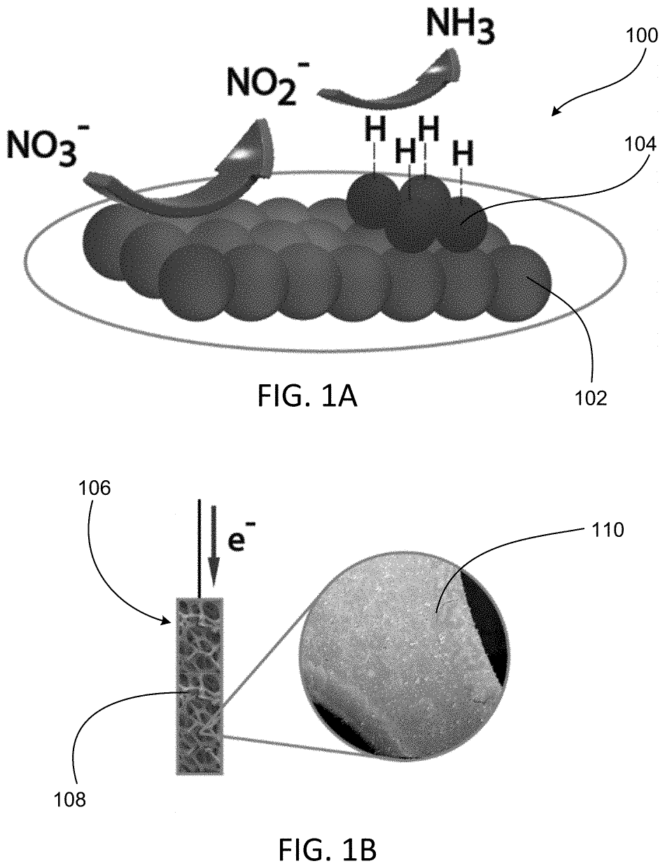

FIG. 1A is a schematic view of the electrocatalytic reduction of nitrate to ammonia on an embodiment of a nanocomposite electrode 100 including a copper substrate 102 and platinum nanoparticles 104. The reduction is depicted as an electrocatalytic reduction of nitrate to yield nitrite facilitated by copper in the copper substrate 102 and an electrocatalytic reduction of nitrite to yield ammonia facilitated by platinum in the platinum nanoparticles 104. FIG. 1B shows scanning electron microscope (SEM) images of a nanocomposite electrode 106 including a porous Cu substrate 108 with electrolytically deposited platinum nanoparticles 110 (inset). The average size of the platinum nanoparticles can be in a range of 50 nm to 500 nm. The platinum nanoparticles can include 0.1 wt % to 1 wt % of the nanoparticle electrode. The platinum nanoparticles extend from pore surfaces of the porous substrate. The platinum nanoparticles are bound to the porous substrate. The porous copper substrate can be copper foam. The porosity of the copper foam can be in a range of 5 to 200 pores per inch (ppi). A volume of the nanocomposite electrode is at least 0.1 cm². Electrocatalytically reducing the nitrate to ammonia has a selectivity of at least 80%.

The nanocomposite electrodes, due at least in part to the porous structure of the copper foam substrate, have a high specific surface area, allowing a higher catalytic reduction of pollutants. Copper (Cu) foam provides favorable kinetics for the nitrate reduction limiting step (Eq. 2), which is associated with the first charge transfer from nitrate to nitrite. The initial reduction of nitrate towards nitrite is a three-step electrochemical-chemical-electrochemical (ECE) mechanism as described in Eqs. 2-4.

NO_{3(ads)}⁻+e⁻→NO_{3(ads)}²⁻limiting step (2)

NO_{3(ads)}²⁻+H₂O→NO_{2(ads)}^{•}+2OH⁻ (3)

NO_{2(ads)}^{•}+e⁻→NO_{2(ads)}⁻ (4)

Copper, being a metal with highly occupied d-orbitals and due to the similarity between its energy level and the lowest unoccupied molecular π* orbital of nitrate, enables a fast reduction of nitrate to nitrite. However, copper-based catalysts by themselves may decrease contaminant removal efficiency over time, since they can be deactivated or corroded.

During the ERN in aqueous media, water reduction to stable adsorbed hydrogen (H(ads), Eq. 5) may be a competitive coexisting reaction, being especially relevant on noble metals such as Pt and Pd. However, the stabilization of H(ads) as a strong reductant on certain metallic surfaces can facilitate indirect electrochemical reduction processes. Contribution of hydrogenation mechanisms to ERN cannot be disregarded due to the strong reducing environment created by the presence of H(ads). Consecutive reactions between the formed nitrogen intermediate species and H(ads) potentially lead to ammonia production in catalytic hydrogenation (Eqs. 6-11).

H₂O+e⁻→H_{(ads)}+OH⁻ (5)

NO_{3(ads)}⁻+2H_{(ads)}→NO_{2(ads)}⁻+H₂O (6)

NO_{2(ads)}⁻+H_{(ads)}→NO_{(ads)}+OH⁻ (7)

NO_{(ads)}+2H_{(ads)}→N_{(ads)}H₂O (8)

N_{(ads)}+H_{(ads)}→NH_{(ads)} (9)

NH_{(ads)}+H_{(ads)}→NH_{2(ads)} (10)

NH_{2(ads)}+H_{(ads)}→NH_{3(ads)} (11)

### EXAMPLES

The nanocomposite electrodes described herein were formed by electrodepositing small loads of Pt (<0.50 wt %) nanoparticles on the surface of a copper foam substrate. Under identical initial pH and nitrate concentration conditions, Cu and Cu—Pt foam electrodes were benchmarked in terms of nitrate conversion figures of merit and product selectivity. Electrical energy per order (EE/O) and the Faradaic efficiency (FE) were calculated to demonstrate the competitiveness of the new synthesized electrodes for ammonia generation and to evaluate the prospective opportunities for the translation of the ERN system to a higher technology readiness level.

### Chemicals and Materials

Reagent grade acetone, hydrochloric acid, potassium tetrachlroroplatinate, sodium nitrate, sodium nitrite, and ammonia sulfate (>99%) were purchased from Sigma-Aldrich. Analytical-grade sodium sulfate (99%, Sigma-Aldrich) was used as the supporting electrolyte. Copper foam of 99.99% purity with 110 pore per inch supplied by Futt was used as an electrode substrate. All solutions were prepared with ultrapure water with resistivity >18.2 MΩ cm at 25° C. (Millipore Milli-Q system).

### Electrodeposition of Pt Over Cu Substrate

The electrodeposition of Pt on Cu material was performed using a potentiostat (PGSTAT302N, Metrohm. USA). A three-electrode system was set up using an Ag/AgCl as the reference electrode, a 5 cm² stainless-steel plate as auxiliary electrode, and copper foam with a 2.25 cm² geometrical area as the working electrode. Before use, the copper foam was washed in acetone using ultrasonic bath during 30 min, rinsed with 0.1 mol L⁻¹ HCl, then thoroughly cleaned with ultrapure water and dried at room temperature. The electrodeposition of platinum on copper was conducted using chronoamperometry under continuous cathodic potential of −0.15 V vs Ag/AgCl (3 mol L⁻¹ KCl) for different times 60 s, 120 s, 180 s, and 360 s. The different nano-composite electrodes were identified by the time of electrodeposition as Cu—Pt 60 s, Cu—Pt 120 s, Cu—Pt 180 s, and Cu—Pt 360 s. The electrodeposition bath consisted of a solution of 3 mmol L⁻¹ K₂PtCl₄ dissolved in 0.5 mol L⁻¹ H₂SO₄. Electrosynthesized nanocomposite Cu—Pt electrodes were rinsed with ultrapure water and dried at room temperature. Dried Cu-foam electrodes were weighed prior and after electrodeposition.

### Electrode Characterization

The morphology difference of Cu foam and Cu—Pt electrodes was characterized by field emission scanning electron microscope (FE-SEM) using an ESEM-FEG XL30 at 10 kV. The FE-SEM microscope was coupled to an energy dispersive X-ray spectroscopy (EDX) for in situ elemental mapping of the Cu—Pt electrodes. Crystallographic composition of the electrodes was evaluated by X-ray diffraction (XRD) using a PANanalytical Aeris Powder by applying Cu K_{α1+2} radiation (λ_{(α1)}=0.154060 nm) at 40 kV and 20 mA current. The oxidation states of copper were evaluated by X-ray photoelectron spectroscopy (XPS) was measured by VG 220i-XL with X-Ray source monochromate Al K-alpha with a line width of 0.7 eV.

### Electrochemical Characterization of Electrodes

Electroanalytical characterization of Cu and Cu—Pt electrodes was carried out by cyclic voltammetry (CV) and linear sweep voltammetry (LSV) in a conventional three electrode system. The electrochemical cell employed the foam (with or without Pt electrodeposition) as working electrode, a stainless-steel plate as auxiliary electrode, and an Ag/AgCl as the reference electrode. The volume of Cu foam electrodes was 1.5 cm×1.5 cm×0.2 cm, and all electrochemical measurements were normalized using the electrode geometrical area (cm²). The electrocatalytic response for direct charge transfer ERN was studied by CV at 10 mV s⁻¹ in solutions of 0.1 mol L⁻¹ Na₂SO₄ as support electrolyte in presence or absence of nitrate ion (10 mmol NaNO₃). The solutions were initially purged with N₂. Additional voltametric analyses were conducted in presence of nitrite ion (10 mmol NaNO₂) allowing reduction peaks identification. The electrochemical active surface (EAS) of the electrodes was evaluated using double layer capacitance in 0.1 mol L⁻¹ Na₂SO₄.

### Electrochemical Reduction of Nitrate

Electrochemical reduction experiments were conducted galvanostatically at 0.09 A (TENMA 72-2720 DC power supply) in an open, undivided cylindrical glass batch reactor containing 100 mL of non-deaerated 30 mg NO₃⁻—N L⁻¹ solutions with 12.5 mM Na₂SO₄ (pH=6.27±0.01 and conductivity=3.04±0.05 mS cm⁻¹) at 25° C. This model solution mimics the nitrate concentration (mg L⁻¹ NO₃⁻—N) typically found in a groundwater containing nitrate over maximum concentration levels. The electrochemical set-up was equipped with two parallel electrodes (geometrical area 1.5 cm×1.5 cm) with an interelectrode gap distance of 1.0 cm. The pristine Cu foam or Pt electrodeposited Cu foams were used as cathode, while a commercial Ti/IrO₂ (DeNora—USA) was used as anode. Batch reactor experiments were continuously mixed using magnetic stirring at 500 rpm to ensure transport from/towards the electrode surface. Samples were withdrawn over time and analyzed for nitrogenous species (NO₃⁻—N, NO₂⁻—N and NH₃—N), conductivity, and pH. Experiments were run in triplicate, and deviations between them were lower than 5% for all trials.

### Analytical Instruments and Procedures

The pH and conductivity were measured using Thermo Scientific Orion Star A221 meters. Nitrate, nitrite, and ammonia were quantified with a HACH DR6000 UV-vis equipment using TNT 835, TNT 839 and TNT 830 HACH kits, respectively. Nitrate conversion was calculated using Eq. (12).

$$Nitrate converstion ( \% ) = \frac{{C}_{nitrate , i} - {C}_{nitrate , t}}{{C}_{nitrate , i}} \times 100 \qquad ( 12 )$$

where C_{nitrate,i} is the nitrate concentration in mg L⁻¹ NO₃⁻—N before treatment, and C_{nitrate,t} is the nitrate concentration at time (t). A mass balance on aqueous nitrogen species led to the determination of the N-volatile species (N₂, NO, NO₂ or N₂O). N-volatiles may be primarily associated with innocuous N₂ evolution.

The selectivity (SNH₃) towards ammonia was calculated using Eq. (13)

$${S}_{{NH}_{3}} ( \% ) = \frac{{C}_{ammonia}}{{C}_{nitrate , i} - {C}_{nitrate , t}} \times 100 \qquad ( 13 )$$

where Cₐₘₘₒₙᵢₐ represents the concentration of ammonia (mg NH₃—N L⁻¹), produced over time.

Faradaic efficiency (FE, Eq. (14)) was used as figure of merit that determines system performance from the number of electrons consumed in an electrochemical reaction relative to the expected theoretical conversion ruled by Faraday's law.

$$FE ( \% ) = \frac{n F {N}_{i}}{3600 I t} \times 100 \qquad ( 14 )$$

where n is the number of electrons required per mol of ammonia, F is the Faraday constant (96 487 C mol⁻¹), Nᵢ, is the mol of ammonia generated during the electrolysis, I is the applied electric current (A), t is the electrolysis time (h), and 3600 is a unit conversion factor (3600 s h⁻¹).

Electrical energy per order (EE/O), was used as an engineering figure of merit to benchmark the electric energy required to reduce NO₃⁻—N concentration by one order of magnitude in a unit volume calculated from Eq. (15) for batch operation mode

$$EE / O ( kWh {m}^{- 3} {order}^{- 1} ) = \frac{{E}_{cell} It}{{V}_{s} log ( {C}_{0} / {C}_{t} )} \qquad ( 15 )$$

where E_{cell} is the average of the cell potential (V), I is current intensity (A), t is time (h), Vs is solution volume (L), and C₀ and Cₜ are the initial and final concentration after one order of magnitude reduction of nitrate. Considering the relationship log(C₀/Cₜ)=0.4343·t·k₁, the EE/O expression can be simplified assuming first-order kinetics according to Eq. (16) where 6.39×10⁻⁴ is a conversion factor:

$$\frac{EE}{O} ( kWh {m}^{- 3} {order}^{- 1} ) = \frac{6.39 \times {10}^{- 4} {E}_{cell} I}{{V}_{s} {k}_{1}} . \qquad ( 16 )$$

Characterizing Copper Foams Electrodeposited with Platinum Nanoparticles

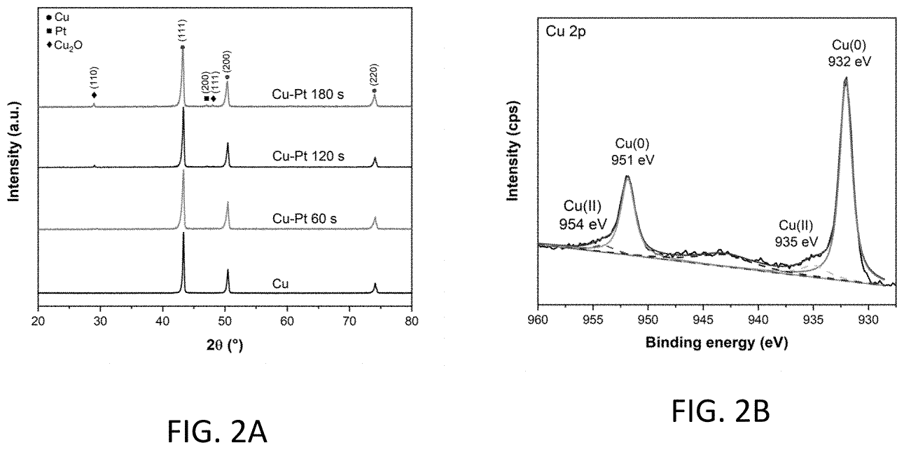

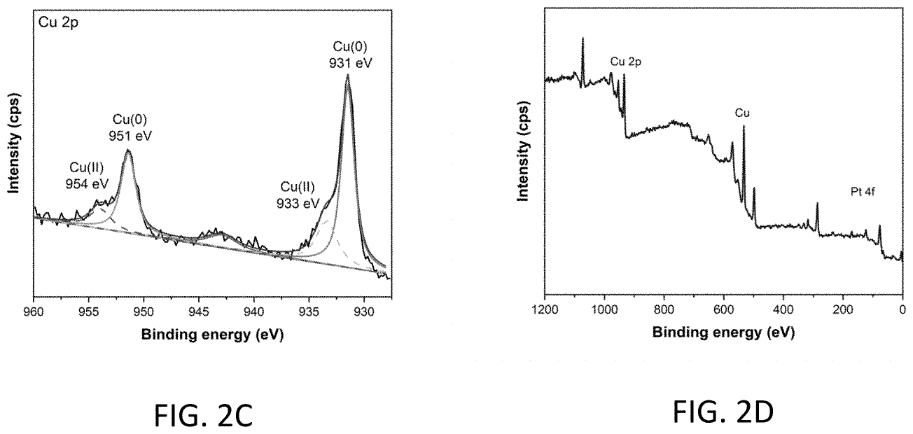

The electrodeposition of platinum over copper foam induced in-situ growth of nanoparticles that form bimetallic catalytic sites. The XRD analyses were carried out to identify the crystallographic structure of the nano-composite bimetallic electrode. FIG. 2A shows peaks of the cubic structure of pure Cu phase (JCPDS No 003-1018) at 43.2, 50.3, and 74.0° corresponding to the planes (111), (200), and (220), respectively. The peaks at 29.0, and 48.0° were attributed to the planes (110) and (111) of Cu₂O cubic structure (JCPDS No 05-0667). The small peak at 47.1° corresponded to the plane (200) of face centered cubic structure of pure Pt phase (JCPDS No 04-0802). Platinum peak increased with the deposition time due to the higher content of Pt. Note that for electrodes with lower than 0.5% compositions of Pt, diffraction peaks of Pt domains were not observed as commonly reported in literature for lower contents in nanocomposite materials. These results suggest that independent Pt domains are formed, suggesting the presence of a bi-metallic nanocomposite.

The oxidation state of copper in Cu foam and Cu—Pt electrode was studied by using XPS. The XPS spectrum of Cu 2p in Cu foam (FIG. 2B) presents the peaks at 932 eV and 951 eV which can be assigned to Cu(0) and/or Cu(I) due to the separation between Cu(0) and Cu(I) that is about 0.3 eV. The small peaks at 935 eV and 954 eV indicate the Cu(II) oxidation state, forming copper oxide (II). Remarkable is the higher intensity peaks at 933 and 954 eV associated to Cu 2p observed in Cu—Pt electrodes (FIG. 2C) that indicates more Cu(II) is present than within the pristine Cu foam. The wide XPS spectrum of Cu—Pt electrode (FIG. 2D) reveals Pt at 76.0 eV.

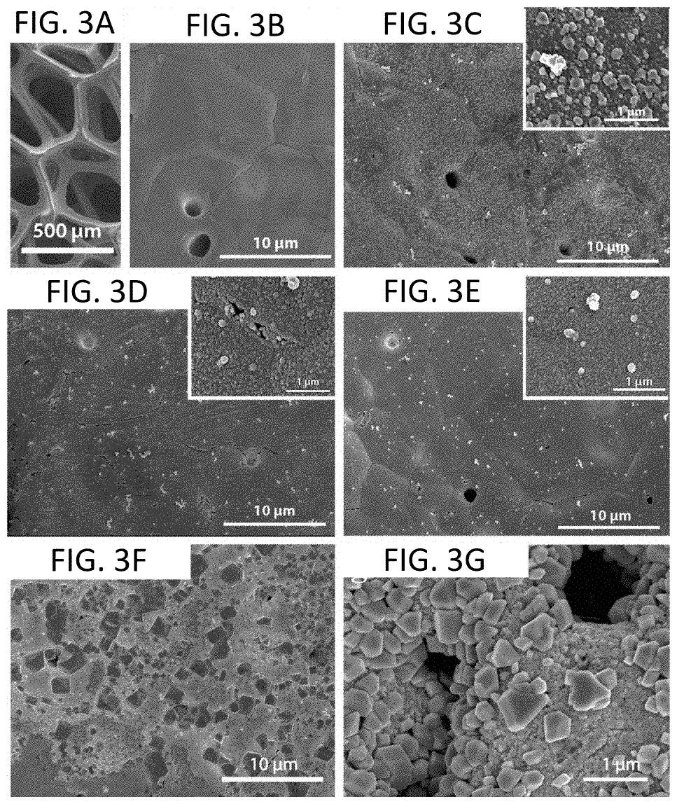

The morphology of Cu foam and Cu—Pt electrodes is illustrated at different magnifications (65×, 3500×12000×) by FE-SEM in FIGS. 3A-3G, with the corresponding inset showing higher magnifications. At 65×, the Cu foam exhibited a 3D framework with macropores as can be seen in FIG. 3A. FIG. 3B and its inset have magnifications of 3500× and 12000×, respectively. FIG. 3B and its inset allowed verification of the smooth surface of pristine Cu foam. In contrast, the Cu—Pt electrodes shown in FIGS. 3C-3G show the presence of nanoparticles attached to the copper surface. The average size and amount of platinum nanoparticles increased with the electrodeposition time. The average size of the nanoparticles was 150±20 nm for Cu—Pt 60 s, 180±40 nm for Cu—Pt 120 s, and 280±50 nm for Cu—Pt 180 s. Longer deposition times promote crystal growth over nucleation of Pt domains on the Cu foam. Thus, as shown in FIG. 3C, Cu—Pt 60 s has more monodispersed particles than Cu—Pt 120 s in FIG. 3D, Cu—Pt 180 s in FIG. 3E, and Cu—Pt 360 s in FIGS. 3F-3G.

Higher deposition times promoted formation of bigger clusters of platinum that can decrease availability of Cu—Pt bimetallic sites given the increase on the surface of homogeneous Pt domains. The elemental composition of the electrodes was obtained by EDS and is summarized in Table 1. The amount of platinum increased with higher depositions from around 6 to 17 wt %, and the small amount of oxygen (1-6 wt %) might correspond to Cu₂O and CuO in agreement with the XRD and XPS analyses.

TABLE 1
Elemental analysis data given from EDS
spectra for different electrodes

| | Composition (wt %) | | | |
|---|---|---|---|---|
| Element | Cu foam | Cu—Pt 60 s | Cu—Pt 120 s | Cu—Pt 180 s |
| Cu | 98.76 | 91.63 | 80.2 | 81.19 |
| O | 1.24 | 2.40 | 6.25 | 1.75 |
| Pt | — | 5.97 | 13.54 | 17.06 |

### Evaluating Electrocatalytic Properties for Nitrate Reduction by Voltammetry

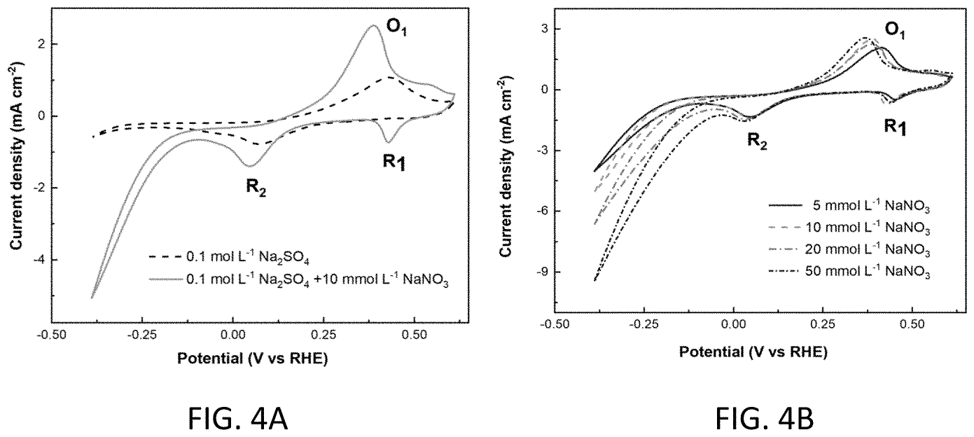

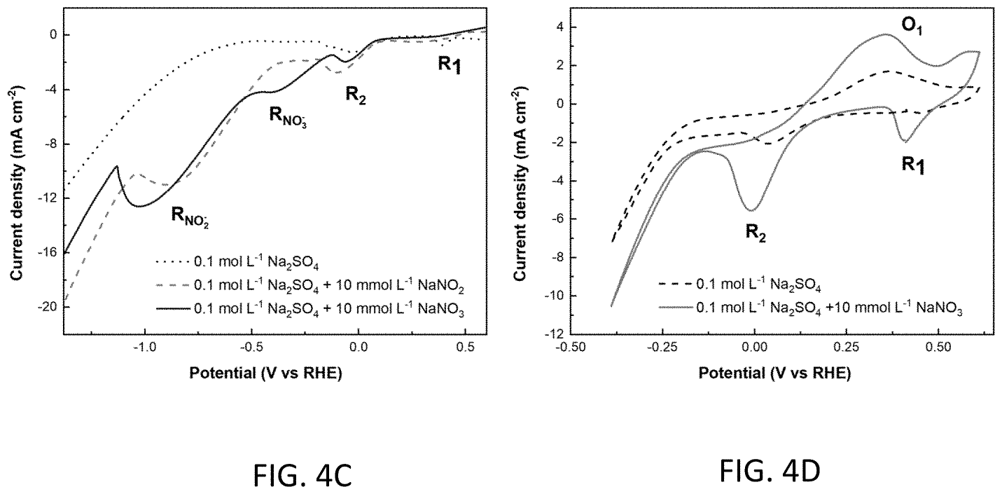

According to the capacitance analysis, EAS values of 0.66, 1.27, 1.59, and 1.84 F g⁻¹ were obtained for Cu, Cu—Pt 60 s, Cu—Pt 120 s, and Cu—Pt 180 s, respectively. This trend shows that with longer electrodeposition times, the EAS increases. Electrochemical analyses of electrodes were recorded using CV in the potential range from −1.0 V to 0 V vs Ag/AgCl at scan rate of 10 mV s⁻¹. FIG. 4A shows the cyclic voltammetry of copper foam in 0.1 Na₂SO₄ without (dotted line) and with 10 mmol L⁻¹ NaNO₃ (solid line). The presence of an oxidation peak and shoulder followed by two reduction peaks can be observed. When CV was conducted in the presence of nitrate, an increase of current response was observed before the onset potential of hydrogen evolution associated with the nitrate reduction. The oxidation (O₁) and reduction (R₁ and R₂) peaks were observed in the presence of both electrolytes. However, to ensure that oxidation (O₁) and reduction (R₁ and R₂) peaks were not associated with nitrate, different concentrations of NaNO₃ (5, 10, 20 and 50 mmol L⁻¹) were added to the system and evaluated in the same potential range at scan rate of 10 mV s⁻¹ (FIG. 4B). Despite the increase of nitrate concentrations, the current peaks did not show notable differences and seemed to be related to an electrode surface process and not to charge transfer processes with nitrate. These peaks have been previously associated with copper oxidation and copper reduction according to Eqs. 17-19.

O₁: 2Cu⁰+H₂O→Cu₂O+2H⁺+2e⁻E=−0.22 V vs Ag/AgCl (17)

R₁: Cu¹⁺+1e⁻→Cu⁰ E=−0.17 V vs Ag/AgCl (18)

R₂: Cu²⁺+2e⁻→Cu⁰ E=−0.57 V vs Ag/AgCl (19)

FIG. 4B illustrates how the increase in nitrate concentration results in a higher cathodic current and a displacement of the onset potential to more positive values. This result is indicative that nitrate reduction occurs at this range of negative potential closely overlapped with hydrogen evolution reaction (HER).

Linear sweep voltammetry (LSV) was conducted to further test the cathodic process taking place at highly negative potentials to elucidate the different reduction processes taking place. Thus, LSV was recorded from 0 V to −2.0 V vs Ag/AgCl at 10 mV s⁻¹ to obtain a wide range of reduction of copper foam (FIG. 4C). The electrochemical behavior recorded in 0.1 mol L⁻¹Na₂SO₄ showed the hydrogen evolution reaction. Then, when 10 mmol L⁻¹ NaNO₃ was added, two new reduction peaks were clearly detected. These two peaks can be associated with nitrate and nitrite reduction. To clearly identify the reduction reaction taking place at each peak potential, the LSV was recorded in 10 mmol L⁻¹ NaNO₂. The LSV in presence of only NO₂⁻ illustrates a single peak located at −1.5 V vs Ag/AgCl. Therefore, the nitrate reduction was located at −1.0 V vs Ag/AgCl (Eq. 20) and nitrite reduction at −1.5 V vs Ag/AgCl (Eq. 21). For Cu—Pt electrodes the reduction peaks were overlapped by HER and difficult to differentiate.

R_{NO}_{₃}_{^{−}}: NO₃⁻+2H⁺+2e⁻→NO₂⁻+H₂O E=−1.0V vs Ag/AgCl (20)

R_{NO}_{₂}_{^{−}}: NO_{2(ads)}⁻+5H₂O+6e⁻→NH₃+70H⁻E=−1.5 V vs Ag/AgCl (21)

FIG. 4D shows a comparative CV analysis for the Cu—Pt nanocomposite foam electrodes in 0.1 mol L⁻¹Na₂SO₄ without (dotted line) and with 10 mmol L⁻¹ NaNO₃ (solid line). The presence of Pt enhances HER that occurs at lower potentials of −0.8 V vs Ag/AgCl than the −1.0 V vs Ag/AgCl for pristine Cu foam. In presence of nitrate, the peaks O₁, R₁ and R₂ maintain their potential values as characteristic for copper. Meanwhile, an increase in current response at −0.8 V vs Ag/AgCl due to the coexistence of ERN and HER reactions in that region of potential is observed.

### Enhanced Electrochemical Reduction of Nitrate by Cu—Pt Nanocomposite Electrodes

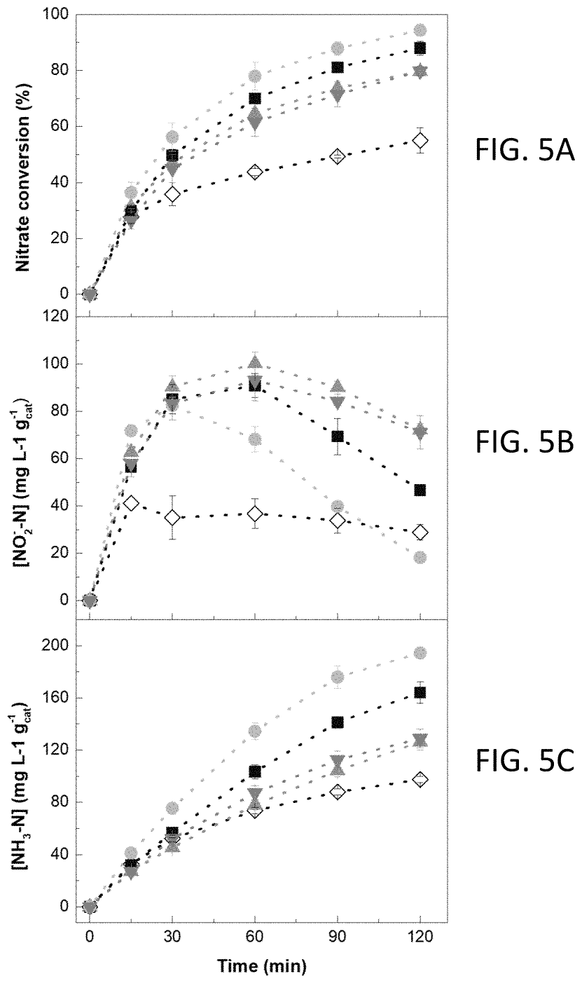

Electrolytic treatment of nitrate solutions was conducted to benchmark the performance of Cu and Cu—Pt nano-enabled foams under comparable conditions. FIG. 5A shows that nano-enabling copper foam with Pt electrodeposited nanoparticles boosted the catalytic activity reaching almost complete reduction of nitrate in 120 min, while pristine copper foam only attained 55% removal. Indeed, optimized Cu—Pt composition shows a drastic acceleration of nitrate reduction kinetics by 4-fold from k₁=1.29×10⁻⁴ s⁻¹ (R²=0.932) for Cu foam up to k₁=4.03×10⁻⁴ s⁻¹ (R²=0.998) for Cu—Pt 180 s (Table 2). To understand how nanoparticles affect the electrocatalytic reduction of nitrate, a blank experiment using electrodeposited Cu nanoparticles (180 s) on Cu foam was performed. After 120 min, ˜57% of nitrate reduction was achieved. These results allow inferring that there is no significant impact of surface area increase by the addition of nanoparticles on ERN; however, they show the synergistic role of bimetallic catalytic sites on the electrochemically driven reduction of nitrate.

TABLE 2
Key fitted and calculated parameters from the ERN experiments
30 mg L⁻¹ NO₃⁻—N in 12.5 mM Na₂SO₄ at 0.09 A
during 120 min of treatment time.

| | | | Nitrate | |
|---|---|---|---|---|
| | E_{cell} | k₁ × 10⁻⁴ | conversion | NH₃—N |
| Electrode | (V) | (s⁻¹) | (%) | (mg L⁻¹ g_{cat}⁻¹) |
| Cu foam | 9.4 ± 0.8 | 1.29 ± 0.05 | 55 ± 4 | 97.5 ± 2.2 |
| Cu—Pt 60 s | 8.4 ± 1.7 | 2.44 ± 0.01 | 80 ± 1 | 126.3 ± 6.2 |
| Cu—Pt 120 s | 8.7 ± 1.9 | 3.08 ± 0.16 | 88 ± 3 | 164.1 ± 8.1 |
| Cu—Pt 180 s | 8.8 ± 0.2 | 4.03 ± 0.51 | 94 ± 2 | 194.4 ± 3.6 |
| Cu—Pt 360 s | 9.9 ± 0.1 | 2.35 ± 0.23 | 80 ± 2 | 128.9 ± 6.4 |

FIG. 5A shows a change on the nitrate removal profile after 15 min of electrolysis when comparing pristine Cu foam with Cu foam with electrodeposited Pt nanoparticles. All the electrodes had an analogous gradual NO₃⁻—N conversion (˜27-35%) until the first 15 min of electrolysis. After that time, it was possible to observe that by increasing the Pt electrodeposition time from 0 s to 180 s, the NO₃−—N conversion gradually increased from 55% for Cu to 80% for Cu—Pt 60 s, 88% for Cu—Pt 120 s, and 94% for Cu—Pt 180 s. However, further increase on Pt loading resulted in a loss of performance attaining 80% for Pt—Cu 360 s. The different behavior can be associated with the different role of electrocatalytic metals in the composite and the conversion at the bimetallic catalytic centers. Copper is an electrocatalyst with excellent capabilities to reduce nitrate to nitrite. The first reduction following Eq. 2 is themed as the limiting step of the overall process in electrochemical systems. This faster reduction to nitrite may be explained by two factors promoted by copper: (i) the ease of adsorption of nitrate on copper surface that facilitates the inner-sphere reduction process, and (ii) the fast charge injection in nitrate facilitated by copper electrocatalytic sites. The reduction of nitrate to nitrite is fundamentally driven by an electrochemical-chemical-electrochemical (ECE) mechanism (Eqs. 2-4). The first electron transfer yields a short lived (˜20 μs) nitrate di-anion radical (NO₃²⁻), which is an unfavored process given the high energy of the lowest unoccupied molecular π* orbital (LUMO π*) of nitrate. Thus, the reduction of nitrate to nitrite can be considered a slow reaction. Metals with highly occupied d-orbitals and open d-orbital shells (i.e., copper) are advantageous given their energy levels similar to nitrate's LUMO π* facilitating charge transfer processes. Cathodic passivation of copper electrodes over time may decrease reduction efficiency, probably associated with the formation of copper oxides. This would explain the kinetics deceleration observed in FIG. 5A after 15 min electrolysis for pristine copper foam and not observed for Cu—Pt electrodes. Electrodepostion of Cu foam with Pt nanoparticles opens alternative reduction mechanisms that can synergistically enhance reduction of nitrate as corroborated experimentally. Referring to FIG. 4D, Platinum incorporation displaces the hydrogen evolution onset potential yielding H_{(ad)} from Eq. 5 and evolving hydrogen at the cathode by Eq. 22.

2H₂O+2e⁻—H₂+2OH⁻ (22)

Hydrogen generation can contribute to the reduction process through catalytic hydrogenation mechanisms. Hydrogen gas (H₂) follows dissociative adsorption on platinoid metals (i.e., Pt) yielding reactive adsorbed atoms of H(ad) that have high reduction potential. The H_{(ad)} enables an indirect electrochemical reduction mechanism that can enact nitrate reduction kinetics in the following ways. First, neighboring H_{(ad)} close to copper atoms can reduce oxidized metal (i.e., Cu₂O, and CuO) to Cu⁰ following a hydrogen spill-over reaction. This reaction regenerates the copper catalytic center enabling faster nitrate reduction, as can be deduced from the trends of FIG. 5A and the higher accumulation of nitrite by-product seen in FIG. 5B. In the case of the experiments using Cu—Pt electrodes, the maximum amount of [NO₂⁻—N] was between 2.0× to 2.4× higher than the bare Cu. Second, nitrite hydrogenation reactions catalyzed by platinum can be extremely fast and efficient despite of being incapable of reducing nitrate. This effect is illustrated by the nitrite concentration profile of FIG. 5B. Note that pristine Cu foam electrode attained a pseudo-constant concentration of nitrite in solution that originates from the balanced continuous generation of nitrite from nitrate reduction following reaction (Eq. 20), and nitrite reduction to ammonia according to Eq. 21. The synergistic effect of the coexistence between hydrogen and electrocatalysis is defined by the Pt loading on the copper foam. When a certain amount of the Pt electrodeposited is surpassed, as in the case of Cu—Pt 360 s, a reverse trend in the NO₃⁻—N conversion was detected. Indeed, the nitrate decay was quite like the one observed for Cu—Pt 60 s. This means that with higher times of electrodeposition that result in higher Pt loading, the formation of bigger Pt clusters may have a detrimental effect. Excess of Pt coverage decreases the electroreduction kinetic rate from nitrate to nitrite since it is mainly driven by copper domains. This behavior is confirmed by the pseudo-first order kinetic constants, which increased from k₁=1.29×10⁻⁴ s⁻¹ (R²=0.932) Cu foam to k₁=4.03×10⁻⁴ s⁻¹ (R²=0.998) Cu—Pt 180 s but decreased to k₁=2.35×10⁻⁴ s⁻¹ (R²=0.989) when using the Cu—Pt 360 s (Table 2).

Electrogeneration of ammonia (FIG. 5C and Table 2) was enhanced 2.0 times from pristine Cu (97.5 mg NH₃—N L⁻¹ g_{cat}⁻¹) to Cu—Pt 180 s (194.4 mg NH₃—N L⁻¹ g_{cat}⁻¹). As observed for the other N-species, the generation of [NH₃—N] decreased for the experiment using Cu—Pt 360 s following a similar trend to Cu—Pt 60 s, achieving final [NH₃—N] values around 126.3-128.9 mg NH₃—N L⁻¹ g_{cat}⁻¹. The amount of the [NH₃—N] reaction product differs depending on the Pt loadings. At higher nitrate conversions, [NH₃—N] selectivity increased, suggesting that nitrite hydrogenation occurred. Under aqueous and room temperature conditions, H₂ would tend to adsorb in a dissociate way on Pt to form H atoms and convert NO₂⁻ to NH₃.

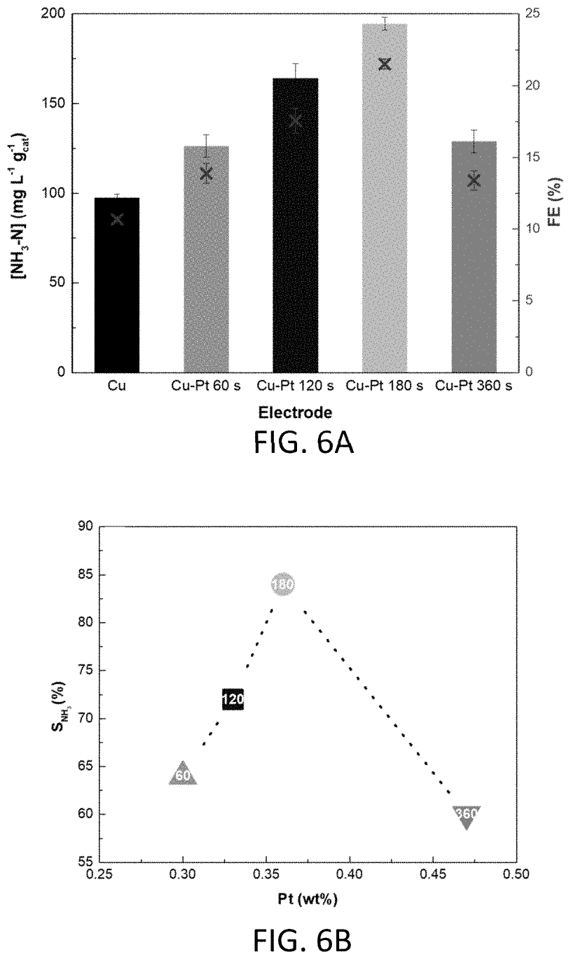

According to FIG. 6A, the Faradaic efficiency (FE) associated to NH₃ production varied between 11 to 22%. The lowest value corresponded to the efficiency with which electrons attained NH₃ using pristine Cu, while the two-fold higher FE corresponded to Cu—Pt 180 s. These FE values may be related to the competition reactions that occur during the treatment process, as is the case of HER previously described. The FE agrees with ammonia productivity that achieved a maximum value of 194.4 mg NH₃—N L⁻¹ g_{cat}⁻¹ for Cu—Pt 180 s. The representation of ammonia selectivity (S_{NH}_{₃}) with respect to Pt loading illustrates a volcano plot that identifies the optimum composition for the nano-composite three-dimensional electrodes (FIG. 6B). A maximum of 84% of selectivity towards NH₃ using 0.36 wt % Pt was obtained for Cu—Pt 180 s. It is important to remark that these nanocomposite electrodes containing lower amounts of Pt (<0.50 wt %) lead to competitive selectivity for resource recovery and fast kinetic rate constants of nitrate abatement for water remediation.

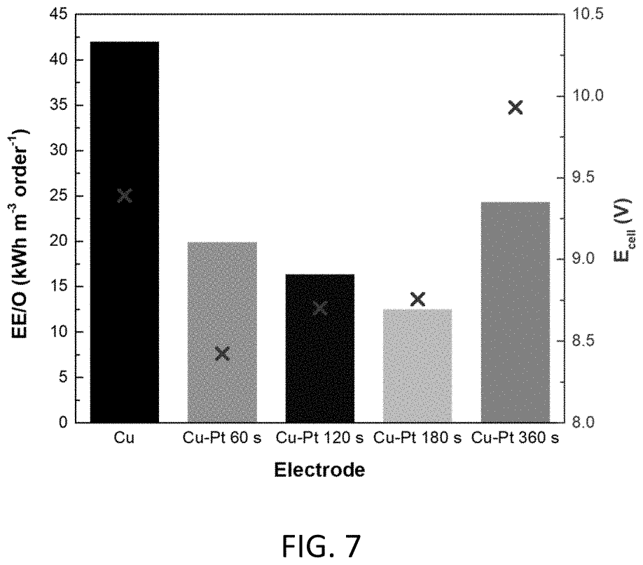

Another engineering figure of merit is the electric energy per order (EE/O) which evaluates the energy necessary to decrease the concentration of NO₃⁻—N one order of magnitude (kWh M⁻³ order⁻¹). According to FIG. 7, the values of the EE/O ranged between 13 and 42 kWh m⁻³ order⁻¹. The lowest and highest EE/O values corresponded to the experiment with Cu—Pt 180 s and Cu foam, respectively. These EE/O results reflect the balance between the nitrate reduction kinetics rate (k₁, Table 2) and the cell potential (E_{cell}, FIG. 6) during the treatment. This means that materials with higher k₁ and lower E_{cell} may attain the lowest EE/O. Therefore, Cu—Pt 180 s seems to be a promising electrocatalytic material for the ERN due to the synergetic effect between Cu and the Pt nano-decoration. The minimization of Pt usage can decrease the capital cost of these bimetallic electrode. Furthermore, the electrodeposition method allows a stable modification by the direct growth of nanostructures strongly attached on the copper substrate.

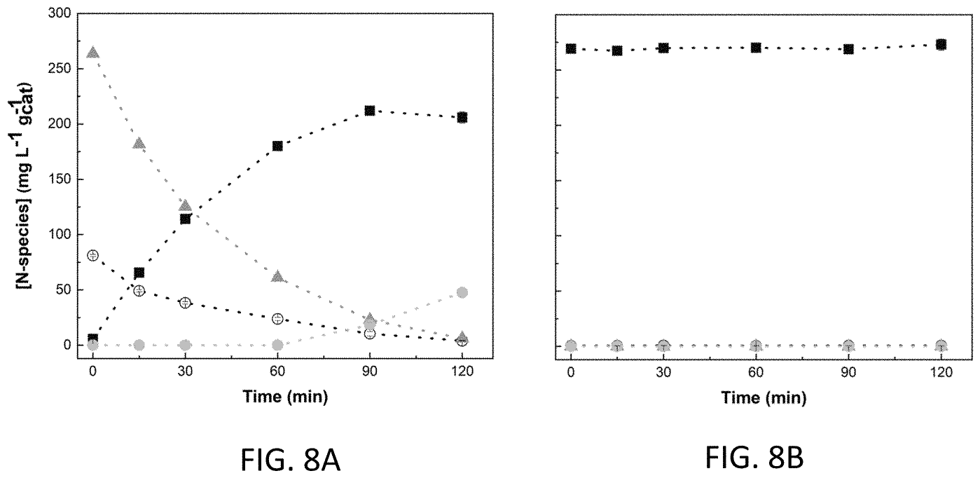

To analyze the role of N-species re-oxidation back to nitrate, control experiments were performed using initial solutions of 30 mg L⁻¹ NO₂⁻—N or 30 mg L⁻¹ NH₃—N solutions with 12.5 mM Na₂SO₄. FIGS. 8A and 8B show nitrogenated species evolution ((◯) NO₃⁻—N, (▴) NO₂⁻—N, (▪) NH₃—N, and (●) N₂—N) over time for the electroreduction of 30 mg L⁻¹ NO₂⁻—N or 30 mg L⁻¹ NH₃—N, respectively in 12.5 mM Na₂SO₄ at 0.09 A, using Cu foam as cathode. FIG. 8A shows that no oxidation of nitrite or ammonia to nitrate occurred. The possibility of ammonia volatilization was disregarded from the blank experiments shown in FIG. 8B, since the content of ammonia remained constant throughout the entire blank experiment.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A nanocomposite electrode comprising:
a porous copper substrate; and
platinum nanoparticles electrolytically deposited on the porous copper substrate.

2. The electrode of claim 1, wherein an average size of the platinum nanoparticles is in a range of 50 nm to 500 nm.

3. The electrode of claim 1, wherein the platinum nanoparticles comprise 0.1 wt % to 1 wt % of the nanocomposite electrode.

4. The electrode of claim 1, wherein the porous copper substrate is a copper foam.

5. The electrode of claim 4, wherein a porosity of the copper foam is in a range of 5 to 200 pores per inch (ppi).

6. The electrode of claim 1, wherein the platinum nanoparticles extend from pore surfaces of the porous substrate.

7. The electrode of claim 1, wherein the platinum nanoparticles are bound to the porous substrate.

8. The electrode of claim 1, wherein a volume of the nanocomposite electrode is at least 0.1 cm².

9. A method of making a nanocomposite electrode, the method comprising:
contacting a porous copper substrate with a solution comprising platinum; and
electrodepositing the platinum on the porous copper substrate to yield the nanocomposite electrode.

10. The method of claim 9, wherein the porous copper substrate is a copper foam.

11. The method of claim 9, wherein the solution comprises a platinum salt.

12. The method of claim 11, wherein a concentration of the platinum salt in the solution is in a range of 1 mmolL⁻¹ to 10 mmolL⁻¹.

13. The method of claim 9, wherein electrodepositing the platinum on the porous copper substrate comprises forming platinum nanoparticles on surfaces of the porous copper substrate.

14. The method of claim 13, wherein an average size of the platinum nanoparticles is in a range of 50 nm to 500 nm.

15. The method of claim 13, wherein the platinum nanoparticles comprise 0.1 wt % to 1 wt % of the nanocomposite electrode.

16. A method of reducing nitrate to ammonia, the method comprising:
contacting the nanocomposite electrode of claim 1 with an aqueous solution comprising nitrate; and
electrocatalytically reducing the nitrate to yield ammonia.

17. The method of claim 16, wherein electrocatalytically reducing the nitrate to yield nitrite, and electrocatalytically reducing the nitrite to yield ammonia.

18. The method of claim 17, wherein electrocatalytically reducing the nitrate to yield nitrite facilitated by copper in porous copper substrate.

19. The method of claim 18, wherein electrocatalytically reducing the nitrite to yield ammonia is facilitated by platinum in the platinum nanoparticles.

20. The method of claim 16, wherein electrocatalytically reducing the nitrate to ammonia has a selectivity of at least 80%.
